(19) United States
(12) Patent Application Publication
(10) Pub. No.: US 2017/0130655 A1
(43) Pub. Date: May 11, 2017

(54) GAS-TURBINE SYSTEM

(71) Applicant: Siemens Aktiengesellschaft, Munich (DE)

(72) Inventors: Andreas Böttcher, Mettmann (DE); Shahrzad Juhnke, Duisburg (DE); Andre Kluge, Dülmen (DE); Boris Ferdinand Kock, Ratingen (DE); Tobias Krieger, Oberhausen (DE)

(73) Assignee: Siemens Aktiengesellschaft, Munich (DE)

(21) Appl. No.: 15/127,356

(22) PCT Filed: Mar. 19, 2015
(86) PCT No.: PCT/EP2015/055765

§ 371 Date: Sep. 19, 2016

(30) Foreign Application Priority Data
Mar. 31, 2014 (DE) 10 2014 206 018.4

(51) Int. Cl. F02C 9/18; F23R 3/50; F23R 3/00; F02C 3/04; F01D 25/14

(52) U.S. Cl. CPC F02C 9/18; F02C 3/04; F01D 25/14; F23R 3/007; F23R 3/50; F05D 2230/80; F05D 2240/35; F05D 2250/294; F05D 2260/606; F05D 2270/08; F23R 2900/03043

(57) ABSTRACT

A gas-turbine system of a power plant, the system having: a compressor; an annular combustion chamber having a burner; and a turbine coupled to the compressor. The gas turbine system has a bypass line for compressed air, the line bypassing the burner and having a flow connection parallel thereto.

### CROSS REFERENCE TO RELATED APPLICATIONS

This application is the US National Stage of International Application No. PCT/EP2015/055765 filed Mar. 19, 2015, and claims the benefit thereof. The International Application claims the benefit of German Application No. DE 102014206018.4 filed Mar. 31, 2014. All of the applications are incorporated by reference herein in their entirety.

### FIELD OF INVENTION

The invention relates to a gas turbine system of a power station, having a compressor, a turbine coupled to the latter and an annular combustion chamber.

### BACKGROUND OF INVENTION

Gas turbine systems conventionally comprise a compressor and a turbine, which are coupled together by means of a common shaft. Arranged between the compressor and the turbine is a combustion chamber, inside which gaseous fuel is combusted with the addition of air compressed by means of the compressor. The resulting exhaust gas expands in the turbine, leading to rotational motion thereof. Also coupled to the shaft is a generator, by means of which electrical energy is generated. To ensure comparatively efficient combustion, the combustion chamber is embodied as an annular combustion chamber. In other words, the combustion chamber is arranged rotationally symmetrically about the shaft coupling the compressor to the turbine.

When the gas turbine system is operating under part load, less fuel reaches the combustion chamber, which leads to a lower combustion temperature. As a result of the lower temperature, the available fuel, conventionally a carbon-containing gas, is not completely reduced to carbon dioxide. A comparatively large proportion of carbon monoxide thus remains in the exhaust gas of the gas turbine system. Consequently, the efficiency of the gas turbine system is reduced under part load operation. Where there are statutory guidelines with regard to the carbon monoxide content in the exhaust gas (for example, a limit value of 10 ppm must not be exceeded), the operator of a gas turbine system must either shut the system down or operate the gas turbine system at a power demand which exceeds the actual demand. The surplus work performed is not used in this case.

### SUMMARY OF INVENTION

An object of the present invention is to provide a power plant gas turbine system which may be operated comparatively efficiently. A further object of the invention is to provide a method for operating a power plant gas turbine system.

According to the invention, the object is achieved with regard to the gas turbine system and with regard to the method as claimed. Advantageous further developments and refinements are the subject matter of the subclaims.

The gas turbine system, also known as a gas turbine, comprises a compressor and a turbine, which are coupled together. In particular, the compressor takes the form of an axial compressor with a shaft rotating when in operation, wherein this shaft transitions into the turbine shaft or is in one piece therewith. An annular combustion chamber with at least one burner is arranged flow-wise between the compressor and the turbine. The annular combustion chamber conveniently comprises a number of such burners. The burner in particular comprises an inflow line for the provision of fuel. By means of the burner, the air compressed by means of the compressor is heated and/or used for combustion of the fuel, wherein an exhaust gas is formed, which is supplied to the turbine. Air is here understood to mean in particular ambient air, but also processed ambient air, for example filtered or treated ambient air with an increased oxygen content, and furthermore also substantially pure oxygen. Moreover, air is understood to mean substantially in particular any gaseous oxidizing agent which undergoes an exothermic chemical reaction inside the gas turbine system, specifically inside the annular combustion chamber, with the fuel supplied.

The gas turbine system further comprises a bypass line, by means of which the burner is bypassed. In other words, the bypass line is connected in parallel with the burner, wherein the bypass line is provided and set up to be supplied with compressed air. The bypass line to this end comprises an inlet which, upstream of the burner, is coupled to the compressor, to the annular combustion chamber or to any components arranged flow-wise therebetween which, during operation, guide the air compressed by means of the compressor. The outlet of the bypass line, on the other hand, is arranged downstream of the burner and opens in particular in the annular combustion chamber or in other components, arranged flow-wise upstream of the turbine, within which the exhaust gas generated during operation by means of the burner is fed to the turbine.

In other words, compressed air is guided around the burner by means of the bypass line, such that it does not participate in combustion or is not heated directly by said combustion. To summarize, the compressor is connected pneumatically to the turbine via the annular combustion chamber comprising the burner, wherein, by means of the bypass line, a parallel connection from the compressor to the turbine is provided which lacks the burner.

The bypass line makes it possible to reduce the air supplied to the burner. In this way, the ratio of the fuel to the air mass provided may be influenced, account thereby being taken in particular of part load operation of the gas turbine with reduced fuel throughput. The ratio of the fuel combusted by means of the burner to the air mass provided for this purpose is appropriately kept constant or at least within a specific range of values over substantially all power demands. In this way, the combustion temperature at which the fuel is combusted is set substantially to a uniform value and the emission of carbon monoxide is stopped or at least reduced. As a result of the air guided around the burner by means of the bypass line being introduced flow-wise upstream of the turbine, the energy stored in this part of the compressed air is recovered and thus the efficiency of the gas turbine system is not reduced.

The gas turbine system is a component part of a power plant, by means of which electrical power is provided. The gas turbine system is, for example, a component part of a gas and steam turbine power plant. The maximum power of the gas turbine system is in particular greater than or equal to 250 MW and in particular greater than or equal to 295 MW. The maximum speed of rotation at which the shaft of the turbine is operated is conveniently greater than 1500 revolutions per minute and for example less than 5000 revolutions per minute. The rotational speed is in particular between 2500 and 3500 revolutions per minute.

The bypass line appropriately opens in an annular groove, which is introduced into a component arranged flow-wise between the burner and the turbine, e.g. is milled thereinto. In particular, this component is arranged around the shaft of the turbine, and the annular groove is rotationally symmetrical relative to the shaft. This enables compressed air inflow that is substantially rotationally symmetrical relative to the shaft and consequently a rotationally symmetrical temperature profile of the component. The groove-like configuration of the annular groove prevents turbulence from arising inside the component conveying the exhaust gas, which could impair the efficiency of the gas turbine system.

The annular groove is conveniently covered by means of a plate. A slot is formed, for example, between the plate and the annular groove, through which the compressed air flows into the component comprising the groove. Particularly, however, the annular groove is covered, in particular substantially completely, by means of the plate. The plate comprises a number of openings, and no slot is formed between the plate and the annular groove. Instead, the plate rests on the edges of the annular groove or the boundaries thereof. Consequently, the compressed air flows through the openings into the component comprising the annular groove. By suitable positioning and dimensioning of the openings, a suitable flow profile for the compressed air is thus enabled within the component. The plate is conveniently of the same material as the component in the region of the annular groove. This ensures that stresses due to different coefficients of thermal expansion of the materials on heating of the gas turbine system, which could otherwise lead to destruction of the component, do not arise.

The annular groove is for example introduced into the annular combustion chamber. In other words, the component comprising the annular groove is the annular combustion chamber. This makes it possible to retrofit an existing gas turbine system by replacing the annular combustion chamber. This additionally enables comparatively efficient mixing between the exhaust gas and the air passed around the burner by means of the bypass line, before the energy stored herein is extracted by means of the turbine.

The annular groove is conveniently milled into the annular combustion chamber, such that existing annular combustion chambers can be retrofitted. In this case, the annular groove is in particular covered by means of the plate consisting of the same material as the annular combustion chamber. The annular combustion chamber is in particular a casting. The annular combustion chamber for example comprises an outer shell and an inner shell, wherein the inner shell constitutes the hub-side boundary of the annular combustion chamber. The outer shell, on the other hand, bounds the annular combustion chamber externally in the radial direction. The outer shell for example comprises the annular groove, which has been introduced into the outer shell over the circumference and faces the inner shell. With such positioning of the annular groove, it is comparatively simple to supply the latter with the compressed air. As an alternative, the inner shell comprises the annular groove, which has likewise been introduced thereinto over the circumference thereof. This additionally makes it possible to insulate the shaft arranged inside the inner shell from the exhaust gas heated by means of the burner.

The bypass line conveniently comprises a slot which has been introduced into the annular combustion chamber on the hub side thereof, in particular into the inner shell. The slot extends in particular axially and appropriately opens into the annular groove. The slot is arranged, for example, on the side of the annular groove facing the compressor. This enables comparatively simple supply of compressed air to the annular groove by introducing the compressed air into the slot. The slot is conveniently covered with a plate, such that uncontrolled outflow of the compressed air from the slot into the combustion chamber is prevented. Instead, the compressed air is supplied substantially completely to the annular groove.

In one embodiment of the invention, the annular groove is covered with thermal tiles, which are in particular made from a ceramic material. Consequently, thermal loading of the annular groove and of the component comprising the annular groove due to the comparatively hot exhaust gas is reduced. The annular groove is conveniently covered by means of the plate, and the plate in turn by means of the thermal tiles, so on the one hand allowing controlled outflow of the air from the annular groove and on the other hand reducing the thermal loading of the plate. In this case, the thermal tiles are in particular spaced from one another, such that the air is allowed to flow through between the thermal tiles.

The gas turbine system particularly comprises two such annular grooves. This improves the inflow behavior of the compressed air into the exhaust gas stream of the burner and makes heat exchange therebetween more efficient. Particularly, the annular combustion chamber in this case comprises the two annular grooves. In this case, one of the annular grooves is introduced into the outer shell and the other into the inner shell. Thus, the comparatively hot exhaust gas is kept apart from the two shells by means of the air guided and compressed by way of the bypass line, so reducing the thermal loading of the annular combustion chamber. The two annular grooves additionally make it possible to select a comparatively small cross-section for the annular grooves, wherein the air volume guided around the burner by means of the bypass line is comparatively large.

Alternatively, either the inner shell or the outer shell comprises the two annular grooves, wherein these are spaced axially relative to one another. Particularly, at least three annular grooves are present, wherein two thereof have been introduced into either the inner shell or the outer shell, the remaining shell comprising the further annular groove. This makes it possible to guide a comparatively large volume of air around the burner, and thus also, in the case of comparatively low power demands on the gas turbine system, to ensure a high temperature in the region of the burner, so leading to comparatively low carbon monoxide emissions.

The gas turbine system conveniently comprises a control circuit and a valve, which are coupled together for signaling. In other words, when in operation the valve is supplied with control commands from the control circuit. The valve itself is a component part of the bypass line, such that the volume of air flowing through the bypass line may be adjusted by means of the valve. Consequently, the control circuit makes it possible to regulate the temperature at which the fuel is combusted inside the combustion chamber. Specifically, when the valve is open, the temperature is increased, whereas when the valve is closed the temperature is reduced. The control circuit is conveniently provided and set up to actuate the valve as a function of power demand on the gas turbine system.

The method serves in operation of a gas turbine system with a compressor, an annular combustion chamber comprising a burner, and a turbine, which are coupled together flow-wise. The gas turbine system further comprises a bypass line for bypassing the burner. As a function of the power demand on the gas turbine system, the bypass line is supplied with compressed air, which is removed from a region located flow-wise between the compressor and the burner. In this case, the quantity of air removed is low when power demand is high and high when power demand is low. The air guided in the bypass line is introduced into the exhaust gas stream generated by the burner downstream of the burner in the direction of flow and subsequently supplied to the turbine. In this way, the energy present in the compressed air is recovered. In particular when the gas turbine system is operating under full load, the quantity of air guided around the burner by means of the bypass line is equal to zero. Adjustment of the compressed air volume guided around the burner by means of the bypass line proceeds by means of the valve, wherein to this end a control command is supplied thereto. The control command is appropriately created by means of the control circuit.

### BRIEF DESCRIPTION OF THE DRAWINGS

Exemplary embodiments of the invention are explained in greater detail below on the basis of drawings, in which:

FIG. 1 is a schematically simplified representation of a gas turbine system,

FIG. 2 is a perspective view of a portion of the gas turbine system,

FIG. 3 is a sectional representation of a portion of an annular combustion chamber with an inner shell and an outer shell,

FIG. 4 is a perspective view of a portion of the inner shell,

FIG. 5 is a sectional representation of a portion of a further embodiment of the inner shell, and

FIG. 6 is a schematic representation of a method for operating the gas turbine system.

### DETAILED DESCRIPTION OF INVENTION

Mutually corresponding parts are provided with the same reference numerals in all the figures.

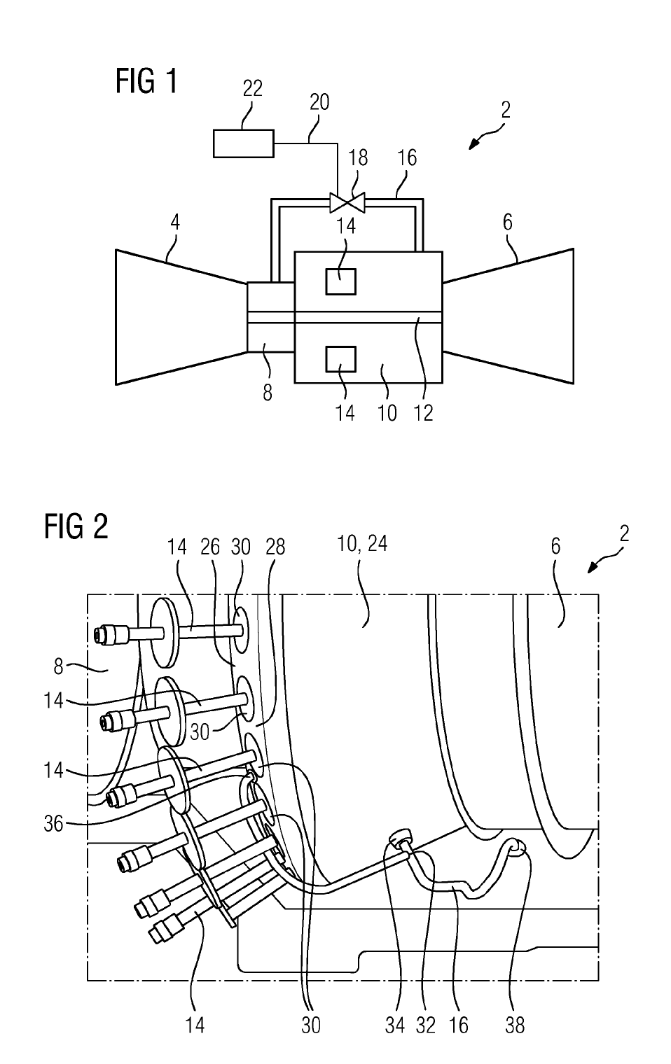

FIG. 1 is a schematically simplified representation of a gas turbine system 2 having a compressor 4 and a turbine 6, wherein an air supply 8 and an annular combustion chamber 10 are arranged flow-wise between the two. The compressor 4 is coupled to the turbine 6 by means of a shaft 12, wherein the shaft 12 drives a generator, not shown here, for generating electrical energy. The shaft 12 is arranged within the center of the annular combustion chamber 10, which has a number of burners 14. In addition, the gas turbine system 2 comprises a bypass line 16 with a valve 18, which branches off from the air supply 8 to bypass the burners 14 and opens into the annular combustion chamber 10 in the region thereof formed between the burners 14 and the turbine 6. The valve 18 is coupled for signaling to a control circuit 22 by means of a control line 20.

When the gas turbine system 2 is in operation, air, which has for example been cooled or enriched with oxygen, enters through the compressor 4 into the gas turbine system 2 and is compressed therein, such that the air present in the air supply 8 has a higher pressure than the surrounding environment. This air is introduced into the annular combustion chamber 10, into which a fuel additionally enters via the burners 14. The fuel reacts with the compressed air provided, forming an exhaust gas, so leading to an increase in the temperature of the exhaust gas compared with the temperature of the compressed air located in the air supply 8. The exhaust gas enters the turbine 6, by means of which the thermal energy is converted into kinetic energy, namely a rotational motion of the shaft 12.

When the gas turbine system 2 is operating under part load, the valve 18 is actuated by means of the control circuit 22 in such a way that air is removed from the air supply 8 by means of the bypass line 16. This air is conveyed around the burners 14 and supplied to the annular combustion chamber 10 in a region in which the chemical reaction of the fuel with the compressed air has already been terminated. There the air which has bypassed the burner 14 is mixed with the exhaust gas, which has arisen as a result of combustion, and is supplied to the turbine 6. As a result of the reduced air supply to the burners 14, the temperature inside the annular combustion chamber 10 is increased, which reduces carbon monoxide formation.

FIG. 2 is a perspective view of a portion of the gas turbine system 2 with the annular combustion chamber 10, which is coupled to the turbine 6. The air supply 8 is located on the side of the annular combustion chamber 10 remote from the turbine 6. The annular combustion chamber 10 comprises an outer shell 24 and an inner shell 26, which comprises a substantially radially extending end wall 28. The end wall 28 comprises a number of bores 30 arranged regularly in the circumferential direction and within each of which one of the burners 14 is arranged. In this case, a slot is formed between each of the burners 14 and the boundary of the respectively associated bore 30, through which slot the compressed air enters the annular combustion chamber 10. The bypass line 16 comprises a branch 32, which connects a first port 34, a second port 36 and a third port 38 together flow-wise. The third port 38 leads, in a manner not shown in any greater detail, to the valve 18 and thence to the flow-wise connection between the bypass line 16 and the air supply 8. The first port 34 is introduced into the outer shell 24 and the second port 36 into the inner shell 26.

FIG. 3 shows the annular combustion chamber 10 in a sectional representation along the shaft 12, wherein only the part of the section located on one of the sides of the shaft 12 is shown. In addition, none of the burners 14 are shown, nor the turbine 6, which is mounted in the assembled state on a terminal 40 opposite the end wall 28. The annular combustion chamber 10 comprises a first annular groove 42, which has been milled into the outer shell 24. The first annular groove 42 extends over the circumference of the outer shell 24 and is both directed in the direction of the inner shell 26 and also arranged between the end wall 28 and the terminal 40. The bypass line 16 ends in the first annular groove 42 via the first port 34. On the side of the first annular groove 42 facing the inner shell 26, said groove is completely covered by means of an annular plate 44, which comprises a number of openings 46. The openings 46 are distributed over the circumference of the plate 44, such that the air from the first annular groove 42 flows into the combustion chamber 10 substantially over the entire circumference of the outer shell 24. The plate 44 is made from the same material as the outer shell 24, and consequently has the same coefficient of thermal expansion. The plate 44 additionally lies flush in a corresponding holder, such that the inside of the outer shell 24 is substantially flat in the region of the first annular groove 42.

The inner shell 26 comprises a second annular groove 48, which is covered in the same way as the first annular groove 42 by means of a plate 50, which likewise comprises openings, not shown here. The material of the plate 50 corresponds to that of the inner shell 26 and the plate 50 is in line with the inner shell 26. The second annular groove 48 is offset compared with the first annular groove 42 in the direction of the end wall 28. Consequently, the air entering the annular combustion chamber 10 through the second annular groove 48 is mixed with the exhaust gas generated by means of the burner 30 prior to mixing of the exhaust gas with the compressed air entering via the second annular groove 42.

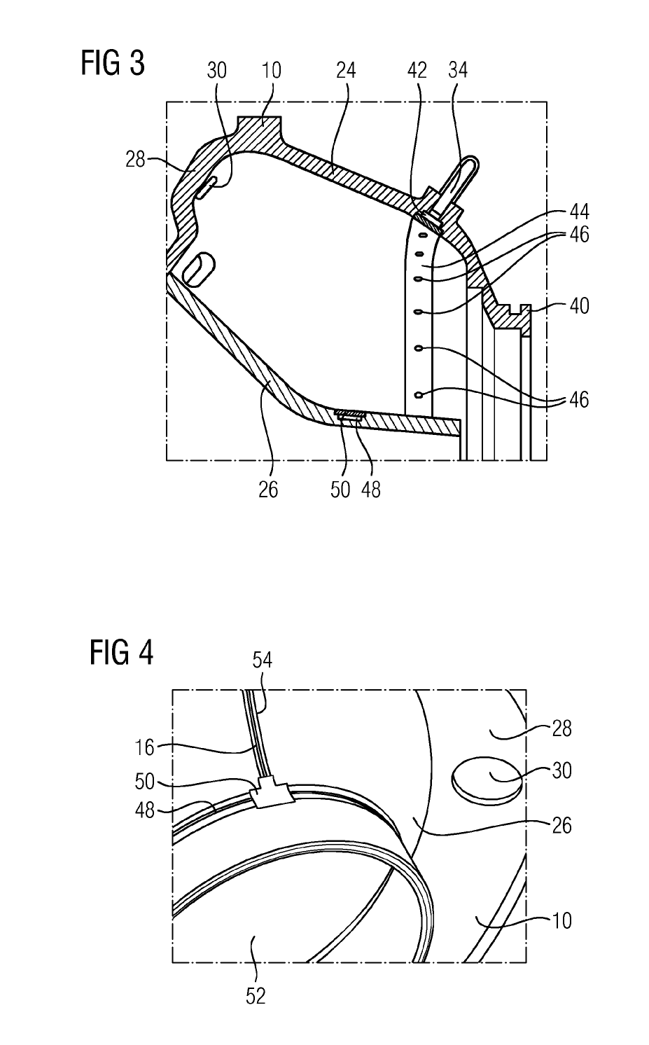

FIG. 4 is a perspective representation of a portion of the inner shell 26 with the end wall 28. The inner shell 26 comprises a central recess 52, within which the shaft 12 is arranged when the gas turbine system 2 is in the assembled state. An axially extending slot 54 of the bypass line 16, which connects the second annular groove 48 flow-wise with the second port 36, extends between the end wall 28 and the second annular groove 48. In the assembled state, the slot 54 is likewise covered by means of the plate 50, of which only a portion is shown, wherein no openings are present in the region of the slot 54. Thus, the compressed air introduced into the slot 54 by means of the second port 36 flows into the second annular groove 48 and thence, distributed substantially regularly around the circumference of the inner shell 26, into the annular combustion chamber 10.

FIG. 5 is a sectional representation parallel to the shaft 12 of a further embodiment of the inner shell 26 with the axially extending slot 54. Here too, the axial slot 54 covered by the plate 50 connects the second port 36 with the second annular groove 48. Furthermore, thermal tiles 56 are shown, with which the inside of the annular combustion chamber 10 is lined. The thermal tiles 56 made from a ceramic material cover the plate 50 and reduce thermal loading of the plate 50 due to the comparatively high combustion temperature of up to 1400° C. Gaps 58 are formed between adjacent thermal tiles 56, through which the compressed air of the second annular groove 48 passes to the exhaust gas. The thermal tiles 56 are likewise fastened to the outer shell 24, as in the exemplary embodiment explained with reference to FIGS. 3 and 4, in which, however, the thermal tiles 56 are not shown.

In comparison with the preceding exemplary embodiment, the embodiment shown in FIG. 5 comprises a third annular groove 60, which extends parallel to the second annular groove 48. The third annular groove 60 is here spaced axially from the second annular groove 48 and offset away from the end wall 28, such that it extends substantially in the axial direction at the same level as the first annular groove 42. The third annular groove 60 is also covered by means of a plate 62 in the manner already explained and connected by means of a further slot, not shown here, with the bypass line 16. To this end, the bypass line 16 comprises a further branch 32 and a fourth port.

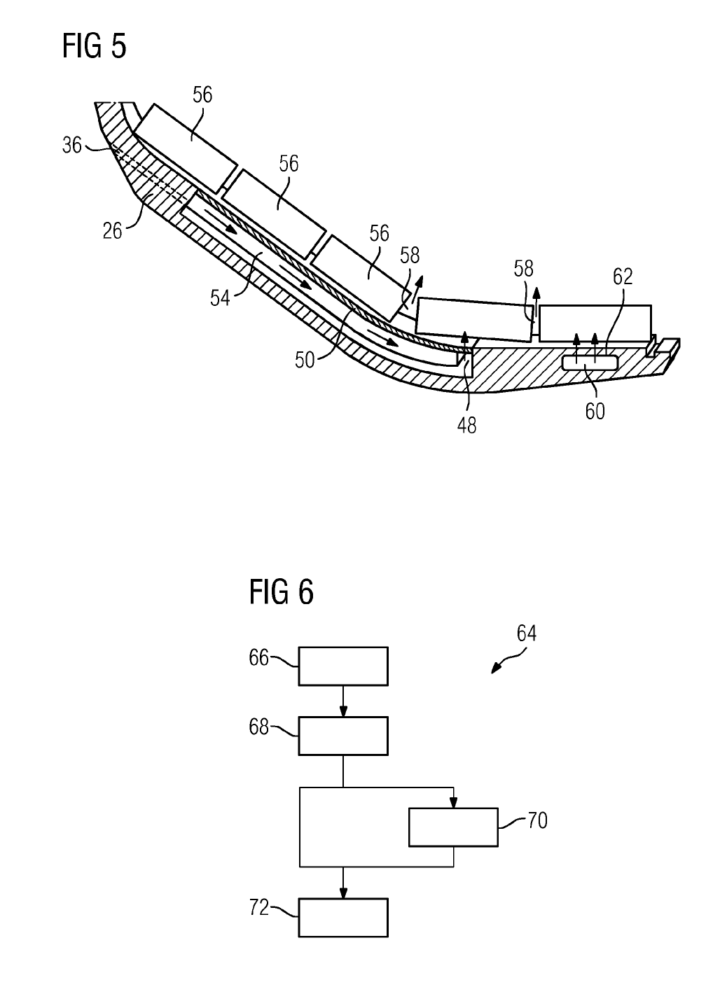

FIG. 6 is a schematic representation of a method 64 for operating the gas turbine system 2. In a first step 66, the power demand on the gas turbine system 2 is determined. In a subsequent second step 68, the quantity of fuel corresponding to the power demand is established. In other words, it is determined how much fuel is needed to operate the gas turbine system 2 in accordance with the power demand. In this case, the quantity of air is also determined which is needed to achieve the power demand, wherein a specific ratio of fuel to the air mass provided is complied with. If the quantity of air needed is less than the quantity of air provided in the air supply by means of the compressor 4 when the valve 18 is closed, in a third step 70 a control command provided by means of the control circuit 22 is supplied to the valve 18, such that the valve 18 is at least partly opened.

The degree of opening of the valve 18 is here selected such that the quantity of air guided around the burner 14 by means of the bypass line 16 corresponds to the difference between the quantity of air provided by means of the compressor 4 and the quantity of air needed for operation of the burner 14. If the quantity of air provided in the air supply 8 is used up completely for operation of the burner 14, the third step 70 does not take place. In a subsequent fourth step 72, the method 64 is terminated.

The invention is not limited to the above-described exemplary embodiments. Rather, other variants of the invention may also be deduced therefrom by a person skilled in the art without going beyond the subject matter of the invention. Furthermore, in particular all the individual features described in connection with the exemplary embodiments may also be combined together in different ways, without going beyond the subject matter of the invention.

1.-10. (canceled)

11. A gas turbine system of a power plant, comprising:
a compressor,
an annular combustion chamber comprising a burner, and
a turbine which is coupled to the compressor, and having a bypass line for compressed air bypassing the burner and connected flow-wise in parallel therewith,
wherein the bypass line opens in an annular groove,
wherein the annular groove is covered by thermal tiles.

12. The gas turbine system as claimed in claim 11,
wherein the annular groove is covered by a plate comprising a number of openings.

13. The gas turbine system as claimed in claim 11,
wherein the annular groove is introduced into the annular combustion chamber.

14. The gas turbine system as claimed in claim 11,
wherein the bypass line comprises an axial slot introduced on the hub side of the annular combustion chamber.

15. The gas turbine system as claimed in claim 11,
wherein the bypass line opens in at least two annular grooves.

16. The gas turbine system as claimed in claim 15,
wherein the annular combustion chamber comprises an outer shell and a hub-side inner shell,
wherein each shell comprises one of the annular grooves.

17. The gas turbine system as claimed in claim 11,
wherein the bypass line comprises a valve coupled for signaling to a control circuit.

18. A method for operating a gas turbine system as claimed in claim 17, the method comprising:
supplying the bypass line with air as a function of power demand, and
supplying the valve with a control command.
